(19) United States
(12) Patent Application Publication
(10) Pub. No.: US 2016/0356616 A1
(43) Pub. Date: Dec. 8, 2016

(54) DISPLAY OF TOTAL VEHICLE TRIP RANGE THAT IS INTUITIVE AND MINIMIZES RANGE ANXIETY

(71) Applicant: GM GLOBAL TECHNOLOGY OPERATIONS LLC, Detroit, MI (US)

(72) Inventors: Michael V. WOON, Ypsilanti, MI (US); Todd ACE, Plymouth, MI (US)

(21) Appl. No.: 14/730,513

(22) Filed: Jun. 4, 2015

(51) Int. Cl. G01C 21/34; G01F 23/00; B60L 11/18

(52) U.S. Cl. CPC G01C 21/3469; B60L 11/1861; G01F 23/0061

(57) ABSTRACT

A system and method are provided for displaying information to a driver of a vehicle, including the initiating of a vehicle trip and measuring a distance traveled since vehicle trip initiation. A remaining driving range distance is calculated based upon an onboard energy of the vehicle, and a total vehicle trip range is also calculated and displayed, including the distance traveled since vehicle trip initiation and the remaining driving range distance. The display of the total vehicle range can be displayed as a display bar with the distance traveled shown on one side of a current location indicator and the remaining driving range distance shown proportionally on a second side of the current location indicator. The display of the total vehicle range can be displayed as the numerical distance traveled and the numerical remaining driving range distance.

### FIELD

The present disclosure relates to improvements in a display of vehicle driving range information for reducing range anxiety.

### BACKGROUND

This section provides background information related to the present disclosure which is not necessarily prior art.

Electric vehicles have become increasingly popular. The cost to recharge the vehicle batteries is significantly less than the cost of fuel for powering a conventional vehicle having an internal combustion engine. In addition, electric vehicles may reduce the amount of harmful emissions that are associated with conventional internal combustion engines.

Because electric vehicles employ a relatively new technology advancement, the time required for recharging the vehicle batteries and the lack of available publicly accessible charging stations can cause electric vehicle drivers to have anxiety regarding the remaining driving range that the vehicle may have for completing their current trip. Existing vehicles are equipped with on-board computer and display systems that calculate an estimated remaining driving range of the vehicle that is displayed for the driver. However, a driver may have a concept of a total distance that is required for their trip, but in the midst of their trip they may have no idea of how much of the trip has been completed and therefore they may not have any idea of how much further distance is remaining in their planned trip. As the remaining driving range distance decreases, the driver can experience anxiety and concern with running out of power to complete a trip or to get to a charging station. Therefore, it is beneficial to a driver of an electric vehicle to have additional information that helps them reduce their range anxiety. Drivers of other hybrid electric vehicles and conventional fuel powered vehicles such as cars, trucks, motorcycles, scooters, golf carts, boats, ATVs, and airplanes may also benefit from additional information that is currently unavailable.

### SUMMARY

This section provides a general summary of the disclosure, and is not a comprehensive disclosure of its full scope or all of its features.

Accordingly, the present disclosure provides a method of displaying information to a driver of a vehicle, comprising the steps of initiating a vehicle trip and measuring a distance traveled since vehicle trip initiation. A remaining driving range distance is calculated based upon a state of charge of the vehicle battery system and/or an amount of fuel remaining and a total vehicle trip range is displayed including the distance traveled since vehicle trip initiation and the remaining driving range distance.

The display of the total vehicle range can be displayed as a display bar with the distance traveled shown on one side of a current location indicator and the remaining driving range distance shown proportionally on a second side of the current location indicator.

The display of the total vehicle range can be displayed as the numerical distance traveled and the numerical remaining driving range distance.

The present disclosure also provides a system for displaying information to a driver of an electric, hybrid electric, or conventional fuel powered vehicle, comprising means for measuring a distance traveled by the vehicle. A vehicle computer tracks a distance traveled since vehicle trip initiation and calculates a remaining driving range distance based upon a state of charge of a vehicle battery system and/or remaining fuel amount. A display panel is in communication with the vehicle computer for displaying the distance traveled since vehicle trip initiation and the remaining driving range distance.

The display panel can display the distance traveled and the remaining driving range as a display bar with the distance traveled shown on one side of a current location indicator and the remaining driving range distance shown proportionally on a second side of the current location indicator.

The display panel can display a numerical distance traveled and a numerical remaining driving range distance.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a graphical display of a display bar and numerical display of the distance traveled since vehicle trip initiation and the remaining driving range distance;

FIG. 2 is a block diagram of components of a graphical display system for reducing range anxiety for a vehicle driver; and

FIG. 3 is a flowchart of the graphical display system according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

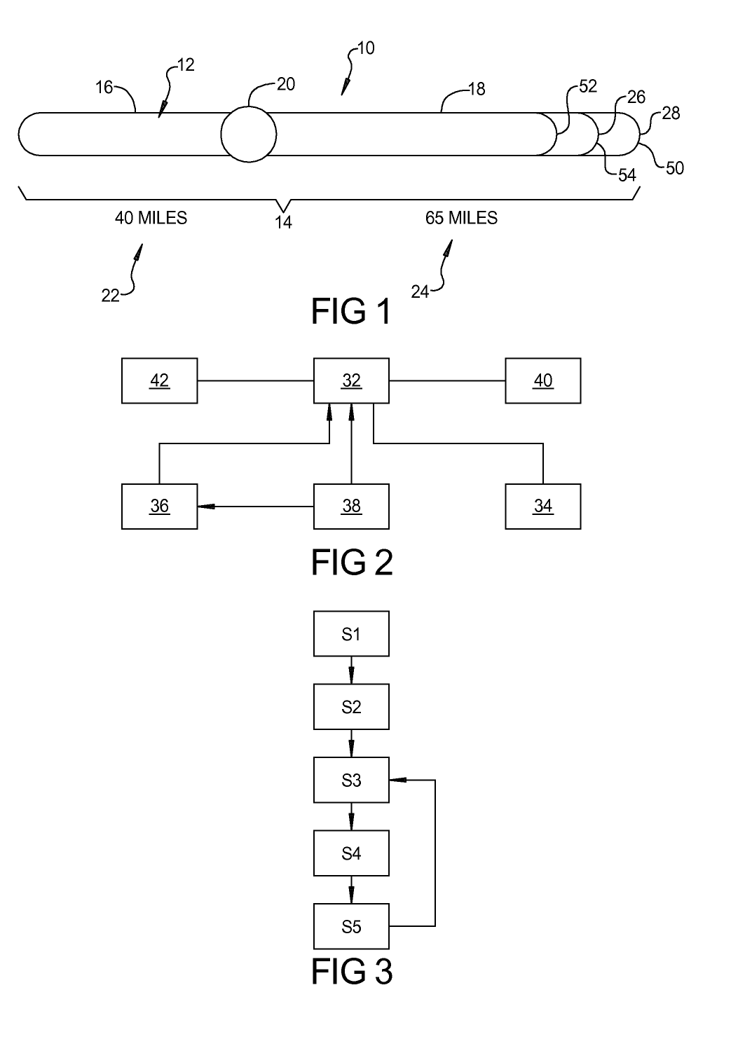

With reference to FIG. 1, a graphical display 10 is provided including a display bar 12 that provides the driver of a vehicle an intuitive display of the total trip range 14 of the vehicle since a trip initiation. In particular, the display bar includes two segments including the distance traveled since trip initiation 16 and the remaining driving range distance 18 separated by a current location indicator 20. The display bar 12 proportionally represents the distance traveled since trip initiation 16 relative to the remaining driving range distance 18 and the total trip range 14. The numerical values of the distance traveled since trip initiation 22 and the remaining driving range distance 24 can also be displayed as an alternative or in addition to the display bar 12. In the sample diagram of FIG. 1, the distance traveled since trip initiation is shown as 40 miles and the remaining driving range distance 24 is shown as 65 miles for purposes of illustration. The rightmost end of the display bar 12 can show a trend by illustrating an original total distance 26 preserved for reference while the real time total distance 28 can fluctuate either shorter or further than the original projected total distance 26. Alternatively, the rightmost end of the display bar 12 can reflect current projected maximum and minimum boundaries 50, 52, respectively, in addition to the expected distance 54. Some combination of these boundaries or distances can also be displayed.

With reference to FIG. 2, a vehicle 30 can be provided with a display system including a computer processor 32. The computer processor 32 receives input from an odometer 34 and an onboard energy system sensor 36 which senses a voltage and/or an amount of fuel remaining of the battery unit/fuel system 38. The computer processor 32 can calculate the distance traveled since trip initiation 16 as well as the remaining driving range distance 18 based upon the remaining battery voltage and/or the remaining amount of fuel and display this information as the graphical display 10 on a display unit 40. A user input device 42 can be provided to allow the user to provide inputs to the computer processor regarding the initiation of a new trip and other desired inputs.

The timing for the initiation of a new vehicle trip can be established by a default setting of the computer processor 32. By way of non-limiting example, the computer processor can initiate a new trip based upon predetermined circumstances such as, for example, initiating a new trip after each charging process, after a fuel charge is completed, after each time a vehicle is re-started, after the vehicle has not been re-started for a predetermined period of time, based upon certain times of day, i.e., morning commute, evening commute, or other alternative circumstances. The vehicle driver can select a default for the particular programming for initiating a new trip from a menu of options using the user input device 42. The default option can be changed or manually overridden by the driver at their discretion to request to initiate a new trip using the user input device 42 and display unit 40.

With reference to FIG. 3, a flowchart is shown representing the method of displaying the total vehicle trip range for minimizing range anxiety. At step S1, a new trip is initiated. At step S2, the computer processor sets the trip distance 20. At step S3, the computer processor updates the trip distance traveled since trip initiation based upon information that can be received from the odometer 34 or other travel distance measurement devices such as a GPS. At step S4, the computer processor 32 calculates the remaining driving range distance based upon the voltage and/or a remaining amount of fuel of the battery unit/fuel system 38 as detected by the onboard energy sensor system 36. The computer processor 32 then provide signals to the display unit 40 to display the total vehicle trip range including the distance traveled since vehicle trip initiation and the remaining driving range distance numerically and/or as a display bar. The process steps S3-S5 are then repeated periodically to dynamically update the display bar and/or numerical display in real time.

The display of the distance traveled 16/22 in addition to the remaining driving range distance available 18/24 in a user friendly display, minimizes driver uncertainty regarding how much the vehicle has traveled and how much further it can go without requiring a re-charge or re-fueling. Accordingly, drivers who may be prone to range anxiety can have an automatic and intuitive way to know the likelihood of completing their trip. This reduces range anxiety and helps the driver maximize the utility of their vehicle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of displaying information to a driver of a vehicle, comprising:
initiating a vehicle trip and measuring a distance traveled since vehicle trip initiation;
calculating a remaining driving range distance based upon an onboard energy of the vehicle; and
displaying a total vehicle trip range including the distance traveled since the vehicle trip initiation and the remaining driving range distance.

2. The method according to claim 1, wherein the display of the total vehicle range is displayed as a display bar with the distance traveled shown on one side of a current location indicator and the remaining driving range distance shown proportionally on a second side of the current location indicator.

3. The method according to claim 1, wherein the display of the total vehicle range is displayed as the numerical distance traveled and the numerical remaining driving range distance.

4. The method according to claim 1, wherein initiating a vehicle trip is based upon predetermined circumstances.

5. The method according to claim 1, wherein the onboard energy of the vehicle is based at least in part upon a state of charge of a vehicle battery.

6. The method according to claim 1, wherein the onboard energy of the vehicle is based at least in part upon an amount of fuel remaining in a fuel system.

7. The method according to claim 2, wherein the display bar can include an original total distance indicator in addition to the remaining driving range distance.

8. The method according to claim 2, wherein the display bar can include projected maximum and minimum driving range boundaries in addition to the remaining driving range distance.

9. A system for displaying information to a driver of a vehicle, comprising;
means for measuring a distance traveled by the vehicle;
a computer processor for tracking a distance traveled since vehicle trip initiation and for calculating a remaining driving range distance based upon an onboard energy of the vehicle; and
a display panel in communication with the computer processor for displaying the distance traveled since vehicle trip initiation and the remaining driving range distance.

10. The system according to claim 9, wherein the display panel displays the distance traveled and the remaining driving range as a display bar with the distance traveled shown on one side of a current location indicator and the remaining driving range distance shown proportionally on a second side of the current location indicator.

11. The system according to claim 9, wherein the display panel displays a numerical distance traveled and a numerical remaining driving range distance.

12. The system according to claim 9, wherein the vehicle trip initiation is based upon predetermined circumstances.

13. The system according to claim 9, wherein the onboard energy of the vehicle is based at least in part upon a state of charge of a vehicle battery.

14. The system according to claim 9, wherein the onboard energy of the vehicle is based at least in part upon an amount of fuel remaining in a fuel system.

15. The system according to claim 10, wherein the display bar can include an original total distance indicator in addition to the remaining driving range distance.

16. The system according to claim 10, wherein the display bar can include projected maximum and minimum driving range boundaries in addition to the remaining driving range distance.
